(19) United States
(12) Patent Application Publication
(10) Pub. No.: US 2011/0191467 A1
(43) Pub. Date: Aug. 4, 2011

(54) Lawful Interception of NAT/PAT

(75) Inventors: Amedeo Imbimbo, Caivano (IT); Pompeo Santoro, Baronissi (IT)

(73) Assignee: TELEFONAKTIEBOLAGET L M ERICSSON (PUBL), Stockholm (SE)

(21) Appl. No.: 13/054,832

(22) PCT Filed: Aug. 15, 2008
(86) PCT No.: PCT/SE2008/050926

§ 371 Date: Apr. 8, 2011

(51) Int. Cl. G06F 15/173

(52) U.S. Cl. 709/224

(57) ABSTRACT

The present invention relates to methods and arrangements for monitoring translation activities in an intermediate node NAT/PAT between a local network and a public network in a communication system. The intermediate node NAT/PAT rewrites addresses related to traffic sent between the networks. The method comprises steps of configuring the intermediate node NAT/PAT to operate as Intercepting Control Element ICE or Data Retention source, and steps of requesting translation information, and reporting translation information to a requesting authority.

### TECHNICAL FIELD

The present invention relates to methods and arrangements for monitoring translation activities in an intermediate node between a local network and a public network in a communication system, which node rewrites addresses related to traffic sent between the networks.

### BACKGROUND

In computer networking, Network Address Translation (NAT, also known as Network Masquerading, Native Address Translation or IP Masquerading) is a technique of transceiving network traffic through a router that involves re-writing the source and/or destination IP addresses and usually also the TCP/UDP port numbers of IP packets as they pass through. Checksums (both IP and TCP/UDP) must also be rewritten to take account of the changes. Most systems using NAT do so in order to enable multiple hosts on a private network to access the Internet using a single public IP address. NAT first became popular as a way to deal with the IPv4 address shortage and to avoid all the difficulty of reserving IP addresses. It has become a standard feature in routers for home and small-office Internet connections, where the price of extra IP addresses would often outweigh the benefits. NAT also adds to security as it disguises the internal network's structure: all traffic appears to outside parties as if it originates from the gateway machine. In a typical configuration, a local network uses one of the designated “private” IP address subnets (the RFC 1918 Private Network Addresses are 192.168.x.x, 172.16.x.x through 172.31.x.x, and 10.x.x.x—using CIDR notation, 192.168/16, 172.16/12, and 10/8), and a router on that network has a private address (such as 192.168.0.1) in that address space. The router is also connected to the Internet with a single “public” address (known as “overloaded” NAT) or multiple “public” addresses assigned by an ISP. As traffic passes from the local network to the Internet, the source address in each packet is translated on the fly from the private addresses to the public address(es). The router tracks basic data about each active connection (particularly the destination address and port). When a reply returns to the router, it uses the connection tracking data it stored during the outbound phase to determine where on the internal network to forward the reply; the TCP or UDP client port numbers are used to demultiplex the packets in the case of overloaded NAT, or IP address and port number when multiple public addresses are available, on packet return. To a system on the Internet, the router itself appears to be the source/destination for this traffic.

Two kinds of network address translation exist:

PAT (Port Address Translation)—The type popularly, but incorrectly, called simply “NAT” (also sometimes named “Network Address Port Translation, NAPT”) refers to network address translation involving the mapping of port numbers, allowing multiple machines to share a single IP address.

Basic NAT—The other, technically simpler, forms—“one-to-one NAT”, “basic NAT”, “static NAT” and “pooled NAT”—involve only address translation, not port mapping. This requires an external IP address for each simultaneous connection. Broadband routers often use this feature, sometimes labelled “DMZ host”, to allow a designated computer to accept all external connections even when the router itself uses the only available external IP address.

NAT with port-translation (i.e. PAT) comes in two sub-types: source address translation (source NAT), which re-writes the IP address of the computer which initiated the connection; and its counterpart, destination address translation (destination NAT). In practice, both are usually used together in coordination for two-way communication.

A Network Address Server NAS is meant to act as a gateway to guard access to internet to a protected resource. A client connects to the NAS. The NAS then connects to another resource asking whether the client's supplied credentials are valid. Based on that answer the NAS then allows or disallows access to the protected resource. NAS is a generic term; different access types foreseen different entities acting as NAS: GGSN for GPRS, BNG or BRAS in case of wireline broadband access. In side a certain internal network (in IETF referred as STUB domain) the user is assigned to a private IP address. Before connecting to the Internet, the NAT function may translate the private address into a public address.

FIG. 1A is part of the prior art and discloses an Intercept Mediation and Delivery Unit IMDU, also called Intercept Unit. The IMDU is a solution for monitoring of Interception Related Information IRI and Content of Communication CC for the same target. The different parts used for interception are disclosed in current Lawful Interception standards (see 3GPP TS 33.108 and 3GPP TS 33.107—Release 7). A Law Enforcement Monitoring Facility LEMF is connected to three Mediation Functions MF, MF2 and MF3 respectively for ADMF, DF2, DF3 i.e. an Administration Function ADMF and two Delivery Functions DF2 and DF3. The Administration Function and the Delivery Functions are each one connected to the LEMF via standardized handover interfaces HI1-HI3, and connected via interfaces X1-X3 to an Intercepting Control Element ICE in a telecommunication system. Together with the delivery functions, the ADMF is used to hide from ICEs that there might be multiple activations by different Law Enforcement Agencies. Messages REQ sent from LEMF to ADMF via HI1 and from the ADMF to the network via the X1_1 interface comprise identities of a target that is to be monitored. The Delivery Function DF2 receives Intercept Related Information IRI from the network via the X2 interface. DF2 is used to distribute the IRI to relevant Law Enforcement Agencies LEAs via the HI2 interface. The Delivery Function DF3 receives Content of Communication CC, i.e. speech and data, on X3 from the ICE. Requests are also sent from the ADMF to the Mediation Function MF2 in the DF2 on an interface X1_2 and to the Mediation Function MF3 in the DF3 on an interface X1_3. The requests sent on X1_3 are used for activation of Content of Communication, and to specify detailed handling options for intercepted CC. In Circuit Switching, DF3 is responsible for call control signaling and bearer transport for an intercepted product. Intercept Related Information IRI, received by DF2 is triggered by Events that in Circuit Switching domain are either call related or non-call related. In Packet Switching domain the events are session related or session unrelated. In Packet Switching domain the events are session related or session unrelated.

FIG. 1B belongs to the prior art and shows the Handover Interfaces between a Data Retention System DRS (see ETSI DTS/LI-00033 V0.8.1 and ETSI DTS/LI-0039) at a Communication Service Provider CSP, and a Requesting Authority RA. The figure shows an Administration Function AdmF used to handle and forward requests from/to the RA. A Mediation and Delivery function MF/DF is used to mediate and deliver requested information. A storage is used to collect and retain all possible data from external the data bases. The generic Handover Interface adopts a two port structure such that administrative request/response information and Retained Data Information are logically separated. The Handover Interface port 1 HIA transports various kinds of administrative, request and response information from/to the Requesting Authority and the organization at the CSP which is responsible for Retained Data matters. The HIA interface may be crossing borders between countries. This possibility is subject to corresponding national law and/or international agreements. The Handover Interface port 2 HIB transports the retained data information from the CSP to the Requesting Authority. The individual retained data parameters have to be sent to the Requesting Authority at least once (if available). The HIB interface may be crossing borders between countries. This possibility is subject to corresponding national law and/or international agreements.

When the NAS acts as LI Intercepting Control Element ICE (also called Intercept Access Point IAP) for users which are targets of interception, the NAS can report to the LEAs, through DF2/MF2, the assigned (private) IP address. Such private IP address is meaningless for investigations that for example are probing the traffic to certain Service Providers, like a web server on the public internet hosting child-porno, or terrorism related material, as the probing activity would show just the translated address after NAT. The LEA won't be able to understand that the traffic data and content intercepted by the application server are linked with the traffic data and content intercepted by the NAS. Moreover if the target is intercepted only for IRI information in the NAS, then there's absolutely no way to connect his activity on the Internet Access available to him, with evidence collected on the public Internet. Having no Content of Communication available, then it is not even possible when data is exchanged unencrypted to view what type of data the target has sent or received. This is rather different compared to IRI only interception in the Circuit Switched world, where the IRI reports the identifiers (the E.164 numbers) of both Calling and Called user.

In a similar way when a NAS and an application server are acting as data retention sources, a data requesting authority won't be able to understand that the traffic data obtained from the application server are linked with the traffic data from NAS if NAT/PAT is performed.

### SUMMARY

The present invention relates to problems caused by incapability to connect target users activity on the intercept access with traffic data including public IP addresses collected by probing on public IP services in networks protected by address translation.

These problems and others are solved by the invention by methods and arrangements to monitor translation activities performed in a node that translates addresses related to traffic sent between networks.

More in detail, the problems are solved by methods and arrangements for monitoring translation activities in an intermediate node between a local network and a public network in a communication system. The intermediate node rewrites addresses and ports related to traffic sent between the networks, from local IP addresses to mapped public IP addresses and ports. The method comprises steps of configuring the intermediate node to operate as Intercepting Control Element or Data Retention source, and steps of reporting translation information to a requesting authority.

In one aspect of the invention, a NAS acts as Intercept access point. The NAS reports an assigned (private) address to a lawful Enforcement Agency when a user, which is target for interception, requests to establish a connection to a public internet service. According to the invention, an intermediate node such as NAT/PAT is configured to operate as Intercepting Control Element and monitoring is activated in the intermediate node on the received private address. After performed translation in the intermediate node, a public IP address, mapped from the private address, will be received from the node to the agency. When probing on a public IP service accessed by the user, the agency will detect the mapped public IP address and be able to connect the public IP address with the target of interception.

In another aspect of the invention, the intermediate node acts as data retention source. A requesting authority will be able to receive private and public IP addresses together with start and end time of a connection. The received information may then be used together with data that has been retained during a time interval corresponding to the start and end time, which data is received
from public IP services, including public IP address and
from the NAS, including, among the others, private IP address and user identities.

The requesting authority may then connect received data from the public internet (including public IP addresses) with user identities, obtained from NAS.

An object of the invention is to enhance the LI/DR solution in order to ensure interception and data retention in case of a target users requests connection to a server in a public network that is protected by address translation. This object and others are achieved by methods, arrangements, nodes, systems and articles of manufacture.

Example of advantages with the invention are that a requesting authority will be able to connect data including public IP addresses collected by probing on public IP services with target users in networks protected by NAT/PAT schema. In this way interception in NAS greatly increases its value and effectiveness. For Operators such implementation would provide means to satisfy legal obligations in spirit rather than in form, and protect customers who have made no wrong from being suspected.

The invention will now be described more in detail with the aid of preferred embodiments in connection with the enclosed drawings.

### BRIEF DESCRIPTION OF THE DRAWINGS

FIG. 1A is part of the prior art and discloses a block schematic illustration of an Intercept Mediation and Delivery Unit attached to an Intercepting Control Element.

FIG. 1B is part of the prior art and discloses a block schematic illustration of a Data Retention System connected to a Requesting Authority.

FIG. 2 is a block schematic illustration disclosing a NAS in a local network and an intermediate node NAT/PAT between the local network and an internet network, both the NAS and the NAT/PAT are acting as Intercept access points. A public IP service is probed by an agency.

FIG. 3 discloses a signal sequence diagram representing a method to connect a public IP address with a target of interception.

FIG. 4 is a block schematic illustration disclosing a NAS, NAS/PAT and an Application Server AS acting as data retention sources in a Data Retention System connected to a Requesting Authority.

FIG. 5 discloses a signal sequence diagram representing a method to connect a public IP address with a monitored target in a Data Retention System.

### DETAILED DESCRIPTION

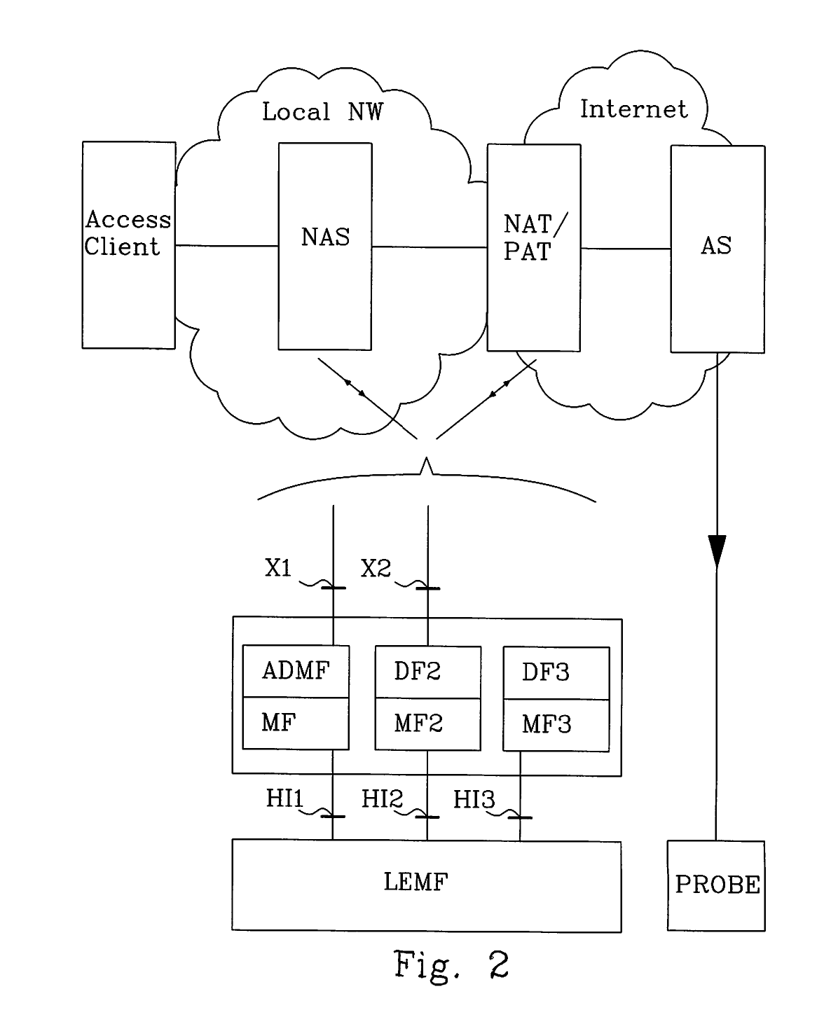

FIG. 2 discloses a system comprising entities that have been explained earlier in the background part of this application. A NAT/PAT server is acting as intermediate node between a local network NW and a public Internet NW. A NAS is located in the local NW between the NAT/PAT server and an Access Client. An Application Server AS is connected in the public Internet NW. An already explained Intercept Mediation and Delivery Unit IMDU and a Law Enforcement Monitoring Facility LEMF are shown in the figure. The interfaces X1 and X2 are both connected to NAS and NAT/PAT respectively as can be seen in the schematic figure. A probe entity PROBE is attached to the Application Server AS.

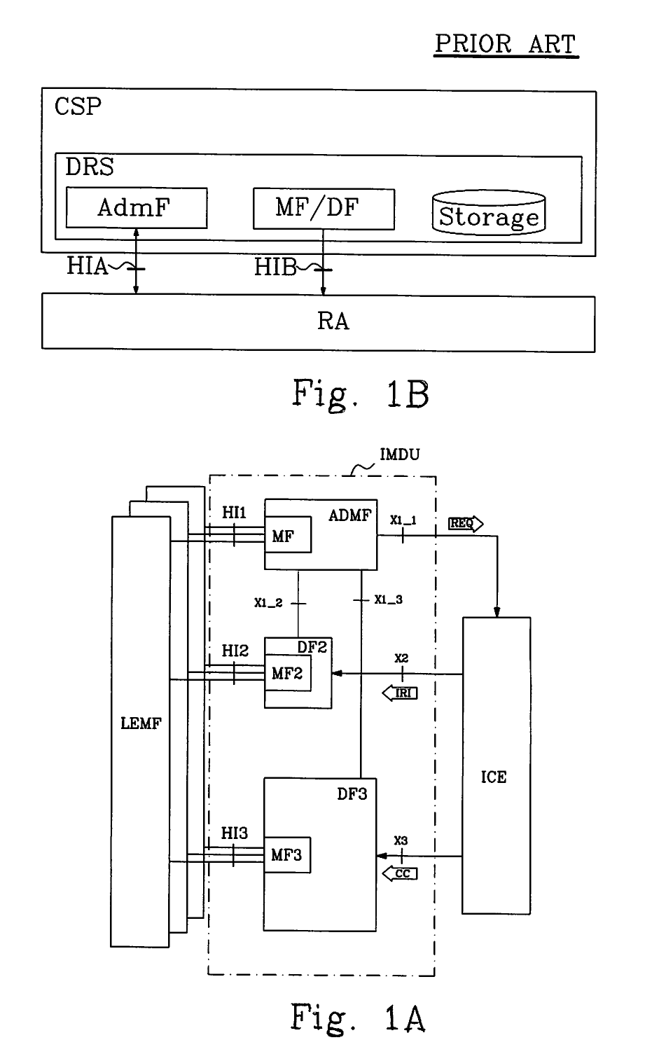

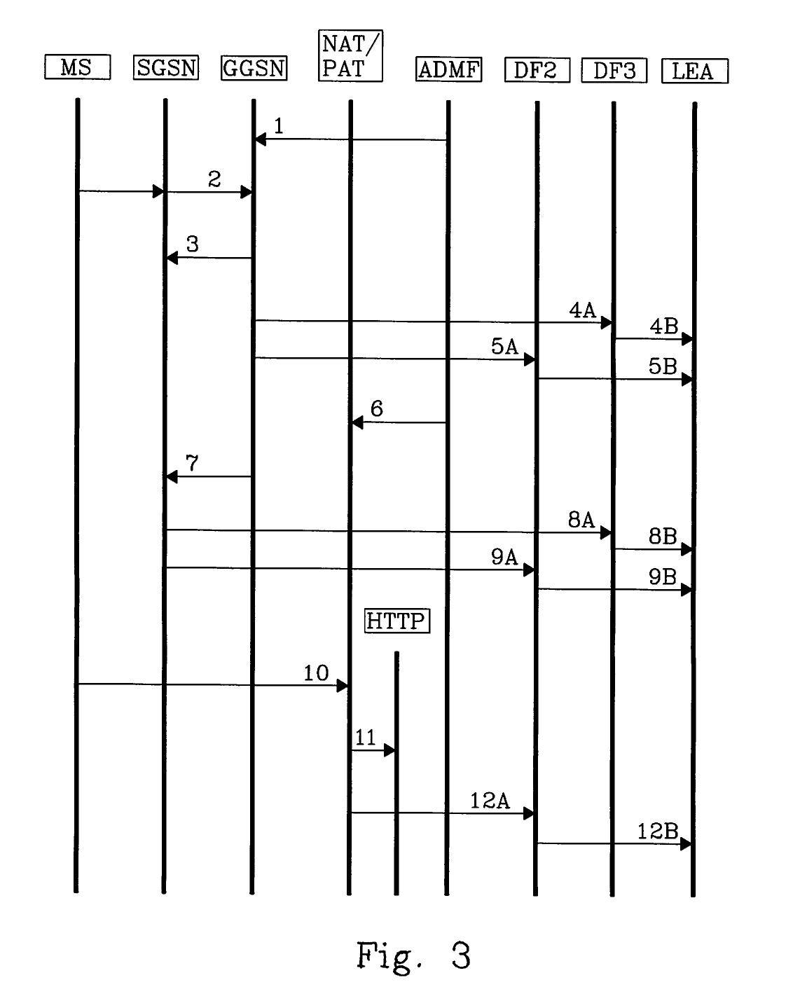

A method (first embodiment) according to the invention will now be explained together with FIG. 3. A prerequisite for the invention is that a Mobile Subscriber MS (corresponds to the Access Client in FIG. 2) is set as target for interception and that the MS requests to establish a connection to an application server in the internet network. The previous mentioned and explained NAS is made up of a Gateway GPRS Support Node GGSN in FIG. 3, i.e. the GGSN acts as NAS and checks if the client's credentials are valid before the request is accepted. The other signalling points in FIG. 3 have been explained earlier together with the FIGS. 1 and 2. The method comprises the following steps:
The agency LEA requests interception of the MS and a Law Enforcement Monitoring Function LEMF (in FIG. 3 the LEMF is symbolized with “LEA”) sends via the HI1 interface, a request to the Administration Function ADMF to activate interception of the target MS. The International Mobile Equipment Identity IMEI, the International Mobile Subscriber Identity IMSI or the Mobile Station International ISDN Number identifies the target. A request 1 is sent from the ADMF to the GGSN (NAS).
The MS sends 2 a request to activate Packet Data protocol PDP context, via a Service GPRS Support Node SGSN, to the GGSN.
After reception of the request, the GGSN checks if the MS's credentials are valid and if so, the GGSN assigns a local (private) IP address to the mobile subscriber MS. The GGSN returns 3 a PDP Context response to the SGSN.
Since the MS is under interception, the GGSN sets-up 4A, 4Ba a packet data tunnel (for transportation of Content of Communication CC) to the LEA, via the Delivery Function DF3.
Since the MS is under interception, the GGSN sends 5A, 5Ba an Intercept Related Information IRI message to the agency LEA, through the Delivery Function DF2, with information related to the PDP context activation. The assigned local (private) IP address is hereby received by the LEA.
When the Delivery Function DF2 receives the report about the successful PDP context activation, according to the invention, the Administration Function ADMF is notified via the X1_2 interface (see FIG. 1A) and the ADMF orders 6 the NAT/PAT server to activate monitoring of the assigned local IP address.
An accept message for activation of PDP context is sent 7 from the GGSN to the SGSN.
Like before, since the MS is under interception, the GGSN sets-up 8A, 8B a packet data tunnel and sends 9A, 9B an IRI message to the agency LEA.
The MS sends an establishment signal 10 to the NAT/PAT server requiring establishment of a connection to the HTTP server in the internet network. The HTTP server in FIG. 3 corresponds to the AS is in FIG. 2. The establishment signal is forwarded 11 from NAT/PAT to the HTTP server after performed translation activities.
According to the invention, for each connection through a firewall (performing NAT/PAT) between the local and Internet NW, i.e. when the GGSN sends an establishment signal to NAT/PAT to connect to a server, the following data will be reported as IRI to the agency:
Start time and end time of the connection;
Real IP Address of the local Internet Service Provider ISP user
Real Port of the local ISP user
Translated IP Address of the local ISP user
Translated Port of the local ISP user
IP Address of the other party of the connection
Port of the other party of the connection

The LEA will receive for each connection the translation of the address and port of the local Internet Service Provider ISP user and the IP address and port of the other party of the communication. Just reporting the performed NAT/PAT would expose as suspects, customers who might have received the same IP address as people committing a crime, since the NAT/PAT server assigns public IP addresses in a dynamic way for each connection. To just depend on time information in NAT/PAT and application server, to match public address with correct user, may be insufficient. There might be a mismatch in the time synchronization in the NAT/PAT and the application server.

Additional data that could be provided from the NAT/PAT server:
Authentication Identifier
Username used to obtain network connection
Connection Protocol

When probing on a public IP service, i.e. on the HTTP server in this example, accessed by the MS, the agency will detect the mapped public IP address. By using the received IRI from the NAT/PAT server the agency is now able to connect the public IP address with the target of interception i.e. with the MS.

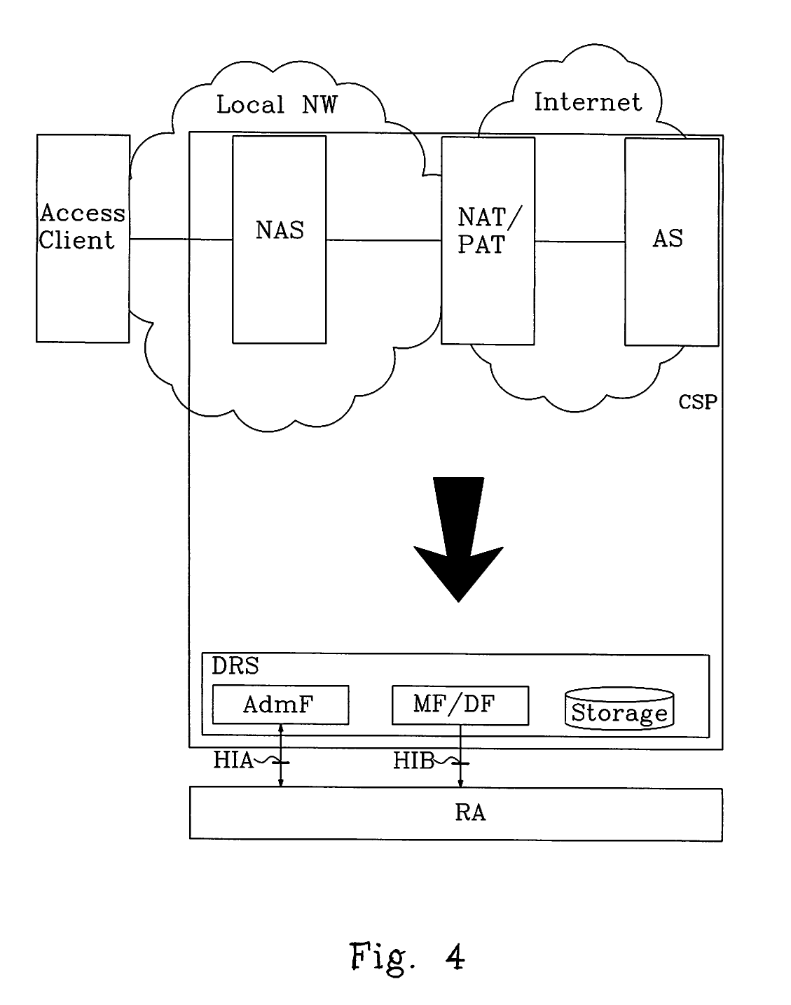

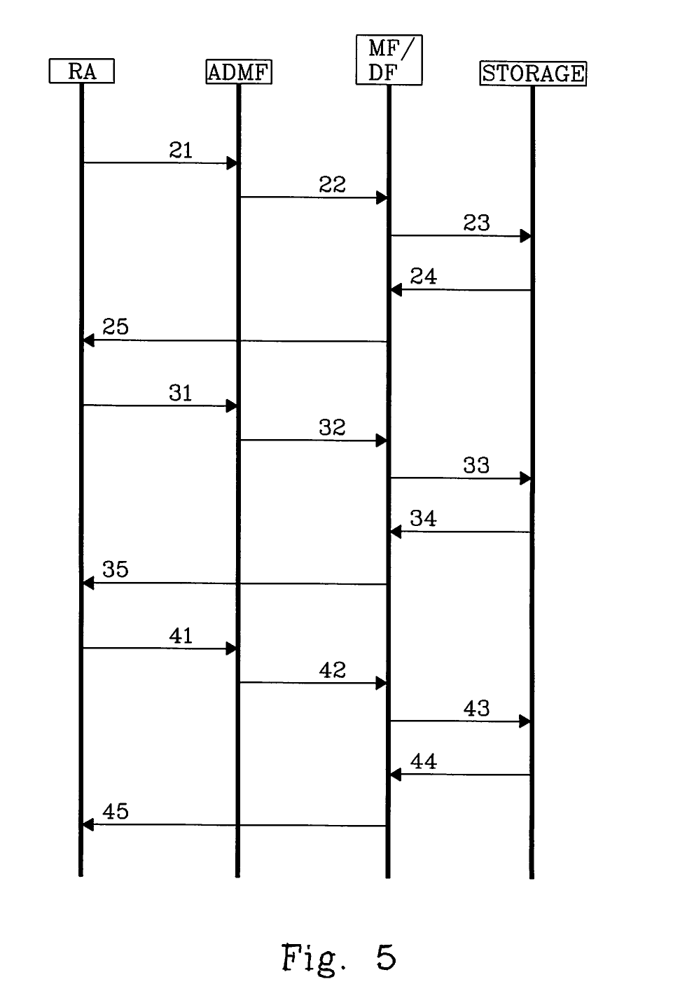

FIG. 4 discloses in a second embodiment a Data Retention configuration. FIG. 4 shows the Handover Interfaces between a Data Retention System DRS at a Communication Service Provider CSP, and a Requesting Authority RA. This configuration including the AdmF, MF/DF, Storage, HIA, HIB and RA has been explained earlier in the background part of this application. The earlier explained NAS, the NAT/PAT and the AS are in this embodiment acting as data retention sources. The transportation of data from the data retention sources NAS, NAT/PAT and AS to the MF/DF is schematically shown with a filled arrow in FIG. 4. Data records are transferred to the mediation function in the Data Retention System, and then data fulfilling configured filtering criteria are mediated from MF/DF to the Storage. Updating of the Storage depends on the policy regulating the notifications with the user, session or operator related data, from the data retention sources towards the storage. Accordingly, the transportation of the data from the sources to the storage via the MF/DF is handled by an automatic data retention system. The automatic data retention system is part of the prior art and the transportation of data is a pre-requisite for this invention. In this example the following data transportations have been made:
Local IP addresses connected to the served user (identified e.g. by IMSI or MSISDN) and to the user access equipment (e.g. identified by IMEI) have been transported from the NAS to the Storage.
Public IP addresses together with time stamps have been transported from the AS to the Storage.

The second embodiment of the invention will now be explained. The method in the second embodiment comprises according to the invention the following steps:
Local IP addresses connected to the translated public IP addresses together with time stamps are in this example transported from the NAT/PAT to the Storage.
A monitoring request regarding access activities in NAS performed by a target identified e.g. by IMEI, IMSI or MSISDN is determined by the requesting Authority RA and sent 21 to the AdmF. The Access Client is in this example the target for the monitoring.
The monitoring request is received by the Administration Function AdmF via the interface HIA.
The AdmF informs 22 the Mediation and Delivery function MF/DF of the request.
The local IP address related to the target is found 23 and fetched 24 by the Mediation and Delivery function MF/DF from the Storage.
The local IP address is sent 25 as Message Data Records from the MF/DF on the interface HIB, to the RA.
A monitoring request regarding translation activities in NAT/PAT related to the fetched local IP address of the target is determined by the requesting Authority RA and sent 31 to the AdmF.
The monitoring request is received by the Administration Function AdmF via the interface HIA.
The AdmF informs 32 the Mediation and Delivery function MF/DF of the request.
The translated public IP address related to the target is found 33 and fetched 34 together with time stamps that represents start and end time of connection, by the Mediation and Delivery function MF/DF from the Storage.
The public IP address and the time stamps are sent 35 as Message Data Records from the MF/DF on the interface HIB, to the RA.
A monitoring request regarding access attempt to the Application Server AS by a user identified by the public IP address is determined by the requesting Authority RA and sent 41 to the AdmF.
The monitoring request is received by the Administration Function AdmF via the interface HIA.
The AdmF informs 42 the Mediation and Delivery function MF/DF of the request.
An access attempt performed by a user represented by the public IP address is found 43 and fetched 44 together with a time stamp that represents time of the access attempt, by the Mediation and Delivery function MF/DF from the Storage.
The public IP address and the time stamp are sent 45 as Message Data Records from the MF/DF on the interface HIB, to the RA.

By using the above method the Requesting Authority has been able to connect the target with the public IP address used when accessing the AS. By comparing received time stamps from NAS and AS, the requesting authority will be able to determine whether the received public IP address that was used when accessing the AS is connected to the target or to someone else.

The reciprocal signaling between the above different Data Retention entities is to be seen just as example. For example can the Storage be an integrated part of the MF/DF. In this example the criteria are sent from the RA but may also be communicated by an intermediary, such as a human operator who receives the command from an authorized source, and then inputs the criteria to the DRS. Different types of applications servers can occur when using the invention for example an E-mail server can act as application server. Also other variations are possible. This is all obvious to someone skilled in the art.

A system that can be used to put the invention into practice is schematically shown in the FIGS. 2 and 4. Enumerated items are shown in the figure as individual elements. In actual implementations of the invention, however, they may be inseparable components of other electronic devices such as a digital computer. Thus, actions described above may be implemented in software that may be embodied in an article of manufacture that includes a program storage medium. The program storage medium includes data signal embodied in one or more of a carrier wave, a computer disk (magnetic, or optical (e.g., CD or DVD, or both), non-volatile memory, tape, a system memory, and a computer hard drive.

The systems and methods of the present invention may be implemented for example on any of the Third Generation Partnership Project (3GPP), European Telecommunications Standards Institute (ETSI), American National Standards Institute (ANSI) or other standard telecommunication network architecture. Other examples are the Institute of Electrical and Electronics Engineers (IEEE) or The Internet Engineering Task Force (IETF).

The description, for purposes of explanation and not limitation, sets forth specific details, such as particular components, electronic circuitry, techniques, etc., in order to provide an understanding of the present invention. But it will be apparent to one skilled in the art that the present invention may be practiced in other embodiments that depart from these specific details. In other instances, detailed descriptions of well-known methods, devices, and techniques, etc., are omitted so as not to obscure the description with unnecessary detail. Individual function blocks are shown in one or more figures. Those skilled in the art will appreciate that functions may be implemented using discrete components or multi-function hardware. Processing functions may be implemented using a programmed microprocessor or general-purpose computer. The invention is not limited to the above described and in the drawings shown embodiments but can be modified within the scope of the enclosed claims.

1. Method for monitoring translation activities in an intermediate node (NAT/PAT) between a local network and a public network in a communication system, which node (NAT/PAT) rewrites addresses related to traffic sent between the networks, comprising steps of configuring the intermediate node (NAT/PAT) to operate as Intercepting Control Element (ICE) or Data Retention source, and steps of requesting translation information, and reporting translation information to a requesting authority.

2. Method for monitoring translation activities according to claim 1 comprising the following further steps:
activate in the node (NAT/PAT) monitoring on a local IP address assigned to a user in the local network, requesting a connection to a server (AS) in the public network;
performing in the intermediate node, mapping of the local IP address to a public IP address; and
reporting translation information, from the intermediate node to a monitoring unit (LEMF).

3. Method for monitoring translation activities according to claim 2 wherein the local IP address belong to a user attempting to access the server (AS), which access attempt is detected by a gateway (NAS) that guards access to the server (AS) and assign the local IP address to the user.

4. Method for monitoring translation activities according to claim 3, which method comprises the following further steps:
sending the local IP address from the gateway (NAS) to the requesting authority; and
forwarding the local IP address from the requesting authority to the node (NAT/PAT).

5. Method for monitoring translation activities according to claim 1, which translation information comprises:
the local IP address; and
the public IP address mapped to the local IP address.

6. Method for monitoring translation activities according to claim 1, which translation information further comprises:
start and end time of the connection.

7. Method for monitoring translation activities according to claim 1, which translation information further comprises:
an IP address of the source (AS) to which the connection is requested.

8. Method for monitoring translation activities according to claim 1, whereby the translation information received from the node (NAT/PAT) is used by the requesting authority to connect the user with a public IP address received after probing the server (AS).

9. Method for monitoring translation activities according to claim 1 whereby the translation information is transported from the intermediate node (NAT/PAT) and retained in storage in a Data Retention System (DRS) before fetched by the requesting authority.

10. Method for monitoring translation activities according to claim 9 whereby the translation information is used together with retained data from a gateway (NAS) by the requesting authority to map a user with a public IP address.

11. Method for monitoring translation activities according to claim 9 whereby the translation information is used together with retained data from a server (AS) by the requesting authority to map a user with a public IP address.

12. Method for monitoring translation activities according to claim 9, which translation information comprises:
the local IP address; and
the public IP address mapped to the local IP address.

13. Method for monitoring translation activities according to claim 9, which translation information comprises:
start and end time of the connection.

14. A computer program loadable into a processor of a telecommunications node, wherein the computer program comprises code adapted to perform the method of claim 1.

15. An arrangement suitable for monitoring translation activities in an intermediate node (NAT/PAT) between a local network and a public network in a communication system, which node (NAT/PAT) rewrites addresses related to traffic sent between the networks, comprising means for configuring the intermediate node (NAT/PAT) to operate as Intercepting Control Element (ICE) or Data Retention source (DRS), and means for requesting translation information, and reporting translation information to a requesting authority.

16. An arrangement suitable for monitoring translation activities according to claim 15 which arrangement further comprises:
means for activating in the node (NAT/PAT) monitoring on a local IP address assigned to a user in the local network, requesting a connection to a server (AS) in the public network;
means for performing in the intermediate node, mapping of the local IP address to a public IP address; and
means for reporting translation information, from the intermediate node to a monitoring unit (LEMF).

17. An arrangement suitable for monitoring translation activities according to claim 16 wherein the local IP address belong to a user attempting to access the server (AS), which access attempt is detected by a gateway (NAS) that guards access to the server (AS) and assign the local IP address to the user.

18. An arrangement suitable for monitoring translation activities according to claim 17, which arrangement further comprises:
means for sending the local IP address from the gateway (NAS) to the requesting authority; and
means for forwarding the local IP address from the requesting authority to the node (NAT/PAT).

19. An arrangement suitable for monitoring translation activities according to claim 15 which arrangement comprises means to retain the translation information in storage in a Data Retention System DRS before fetched by the requesting authority.
